(19) United States
(12) Patent Application Publication
(10) Pub. No.: US 2011/0131181 A1
(43) Pub. Date: Jun. 2, 2011

(54) INFORMATION PROCESSING DEVICE AND COMPUTER READABLE STORAGE MEDIUM STORING PROGRAM

(75) Inventors: Syuichi IKUTA, Takamatsu (JP); Souta KUME, Takamatsu (JP); Hitoshi KAMURA, Takamatsu (JP)

(73) Assignee: FUJITSU LIMITED, Kawasaki-shi (JP)

(21) Appl. No.: 12/953,020

(22) Filed: Nov. 23, 2010

(30) Foreign Application Priority Data
Nov. 27, 2009 (JP) 2009-270559

(51) Int. Cl. G06F 17/30

(52) U.S. Cl. 707/610; 707/822; 707/E17.01

(57) ABSTRACT

An information processing device includes a storage to store a plurality of original files and a processor to execute a first process including obtaining an acquisition request to request an acquisition of a first file descriptor assigned to a first file specified among the original files, the acquisition request being generated in a second process executed by the processor, determining whether or not the first file is designated as a file to be protected, generating a second file on a basis of the first file when the first file is determined to be designated as the file to be protected, and acquiring a second file descriptor assigned to the second file in reply to the acquisition request.

### CROSS-REFERENCE TO RELATED APPLICATIONS

This application is based upon and claims the benefit of priority of the prior Japanese Patent Application No.2009-270559, filed on Nov. 27, 2009, the entire contents of which are incorporated herein by reference.

1. Field

The embodiment of an invention relates to an information processing device and a computer program that, even when data to be protected is changed, can restore the data to its original state.

2. Background

Computers in which an operating system (OS) and the like operate are storing various kinds of data for constructing a software environment in which the OS can operate normally. If such a computer is installed at a place, such as a school, where the computer will be used by many users, these pieces of data may be changed by the users. In such cases, it is necessary to restore the pieces of data to their original state in order to maintain the same software environment on the computer.

Methods for restoring data include a method of, when overwriting the original data stored in a disk drive with new data, storing the new data in a disk position different from the disk position where the original data is stored. In this method, when the original data is needed, the data is read from the disk position where the data is stored. Thus, even when the data is changed, it can be restored to its previous state (for example, Japanese Patent No. 3797864).

In Japanese Patent No. 3797864, however, an error may occur, for example, when a user attempts to read the original data, and the original data may be corrupted owing to the error. This may make it difficult to read the original data, that is, to restore the data to its previous state reliably. Moreover, there is a need to manage the disk position where the data is stored, which may impose an additional processing load on the device and thus affect processes to be performed by the user. It is possible to copy (back up) the original data to another storage area or the like periodically; however, this requires a storage area for backup, causing a cost increase.

### SUMMARY

According to an aspect of an embodiment, an information processing device includes a storage to store a plurality of original files and a processor to execute a first process including obtaining an acquisition request to request an acquisition of a first file descriptor assigned to a first file specified among the original files, the acquisition request being generated in a second process executed by the processor, determining whether or not the first file is designated as a file to be protected, generating a second file on a basis of the first file when the first file is determined to be designated as the file to be protected, and acquiring a second file descriptor assigned to the second file in reply to the acquisition request.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic drawing illustrating a file restoration process performed by an information processing device according to an embodiment of the present invention.

FIG. 2 is a schematic diagram illustrating an electrical configuration of the information processing device according to this embodiment.

FIG. 3A is a diagram schematically illustrating a table used to perform a file restoration process.

FIG. 3B is a diagram schematically illustrating a table used to perform a file restoration process.

FIG. 3C is a diagram schematically illustrating a table used to perform a file restoration process.

FIG. 4A is a schematic diagram illustrating an original storage area, a work area, and a pre-copy area.

FIG. 4B is a schematic diagram illustrating an original storage area, a work area, and a pre-copy area.

FIG. 4C is a schematic diagram illustrating an original storage area, a work area, and a pre-copy area.

FIG. 5A is a schematic diagram illustrating an original storage area, a work area, and a pre-copy area.

FIG. 5B is a schematic diagram illustrating an original storage area, a work area, and a pre-copy area.

FIG. 6 is a flowchart illustrating a process performed by the information processing device.

FIG. 7 is a flowchart illustrating a work area file process.

FIG. 8 is a flowchart illustrating a pre-copy process.

### DESCRIPTION OF EMBODIMENT

Now, an information processing device and a computer program according to an embodiment will be described with reference to the accompanying drawings.

The information processing device according to this embodiment is, for example, a desktop or notebook, general-purpose personal computer and performs a file restoration process. A file restoration process refers to a process of, when a data file stored in the information processing device is rewritten by a user, restoring the data file to its original state. In the following description, data files that have yet to be rewritten will be referred to as the original data files. Rewriting of a data file includes deletion of the data file.

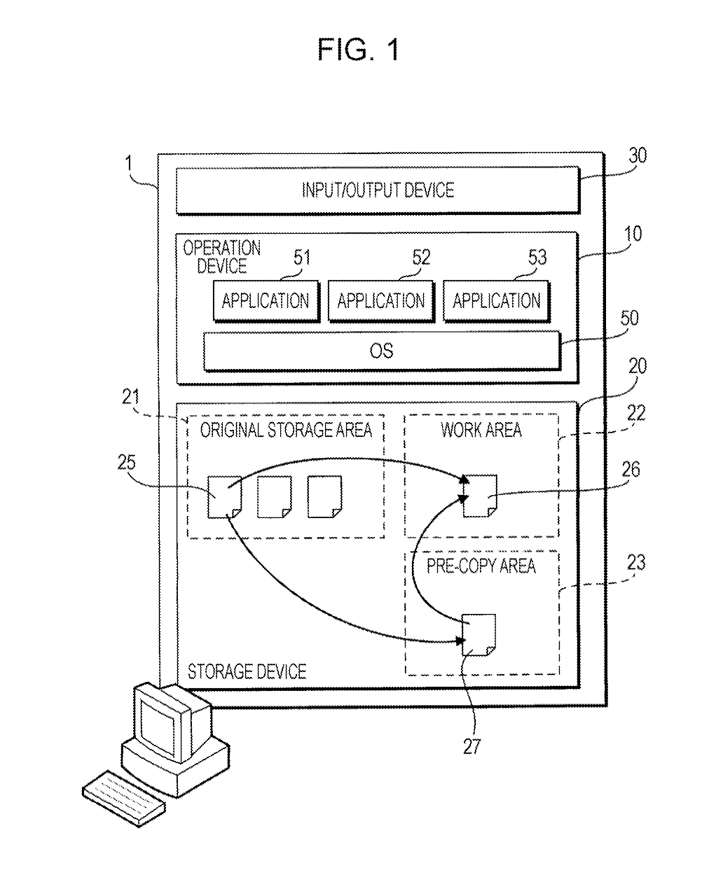

FIG. 1 is a schematic drawing illustrating a file restoration process performed by the information processing device according to this embodiment.

An information processing device 1 includes an operation device 10, a storage device 20, and an input/output device 30. In the operation device 10, an OS 50, such as Windows® and Linux®, multiple application programs (hereafter simply referred to as applications) 51, 52, and 53, and the like are kept executable. The storage device 20 is, for example, a non-volatile storage device such as a hard disk drive (HDD) or solid state drive (SSD) and stores multiple data files. The storage device 20 may be a volatile storage device, such as a dynamic random access memory (DRAM) or static random access memory (SRAM), or a combination of a non-volatile storage device and a volatile storage device. The input/output device 30 includes a keyboard, a mouse, and a monitor and receives an operation performed by a user to display necessary information.

The storage device 20 includes an original storage area (first storage area) 21, a work area (second storage area) 22, and a pre-copy area (third storage area) 23 as storage areas for storing data files. These data files are files about the OS 50, the application 51, or the like and are generated when programs such as the OS 50 are installed into the information processing device 1 or generated by the operator of the information processing device 1, such as the administrator. The data files generated are stored in the original storage area 21 as the original data files (hereafter referred to as the original files) 25. The original files 25 are read by the operation device 10 when the OS or the like 50 is started, thereby constructing a software environment according to the original files in the operation device 10.

Subsequently, the original files 25 are accessed by the operation device 10. The operation device 10 accesses an original file 25 specified by the user, for example, via the application 51. The operation device 10, which performs a processing procedure as a user application, such as the application 51, that operates on the OS 50, accesses the specified original file 25 using the file system function provided by the OS 50. This is because a direct operation by the process of the user application, of a file stored in the storage device 20 is restricted by the OS 50. In this embodiment, the user application is not limited to an application created by the user of the information processing device 1 and may be any program operable on the OS 50.

In the above-mentioned access process using the file system function, the process of the user application acquires a file descriptor (also called a file handler) corresponding to the data file stored in the storage device 20 using the file system function provided by the OS 50. The process of the user application then issues a request for a file operation, such as reference to or write into the data file, to the OS 50 using the acquired file descriptor, thereby performing the desired file operation using the function provided by the OS 50. The above-mentioned file operation request is not limited to a request for reference to or write into the data file and may be a request for transfer, deletion, or the like of the data file. As described above, in order for the operation device 10, which performs the processing procedure of the user application, to access a data file stored in the storage device 20, the process of the application issues, to the OS 50, a request for acquisition of a file descriptor corresponding to the data file, as well as issues, thereto, a request for operation of the data file using the acquired file descriptor.

In this embodiment, the original files 25 include a file previously designated as a file to be protected (restored). If the original file 25 accessed by the operation device 10 is a file to be protected, the original file 25 is copied to the work area 22. Before performing this copy process, it may be determined whether a copy file 26 corresponding to the original file 25 is already stored in the work area 22. If it is determined that the copy file 26 is already stored, the copy process may be omitted. An access to the original file 25 by the operation device 10 refers to issuing a request for acquisition of a file descriptor in order for the operation device 10, which performs the processing procedure of the user application, to perform an operation on the original file 25. File descriptor acquisition requests include those to perform a reference process, where data is acquired from a file, and those to perform an update process, where data is written into a file.

In this embodiment, the original file 25 to be protected is copied to the work area 22 only when there is issued a file descriptor acquisition request for update. That is, in a process where data is acquired from the original file 25 to be protected, the original file 25 is not copied to the work area 22. Accordingly, the time required to perform the above-mentioned copy process for reference is eliminated, which can reduce the processing time to be taken before completing acquisition of data from the original file 25 to be protected.

When the original file 25 to be protected is copied to the work area 22, the operation device 10 changes the access destination from the original file 25 stored in the original storage area 21 to the original file 25 copied to the work area 22, that is, the copy file 26. Specifically, the operation device 10 according to this embodiment detects that a file descriptor acquisition request for updating the original file 25 has been issued and acquires a file descriptor corresponding to the copy file 26 of the original file 25, stored in the work area 22. The operation device 10 then reports the acquired file descriptor corresponding to the copy file 26 to the process of the use application, which is the request source.

Thus, the process by the application issues a file operation request to the OS 50 using the file descriptor corresponding to the copy file 26 stored in the work area 22. In accordance with to the file operation request received from the process of the application, the operation device 10, which performs the processing procedure of the OS 50, performs a file operation, such as rewriting of the accessed copy file 26 in the work area 22. This prevents the original file 25 to be protected from being rewritten by the application. Thus, even when there is issued a request for a file operation, such as rewriting of the data file to be protected, performance of the restoration process according to this embodiment allows construction of the same software environment as that prior to the issuance of the file operation request in the operation device 10. In this embodiment, the copy file 26 in the work area 22 is deleted when the OS 50 is started.

Moreover, the original file 25 to be protected, accessed by the operation device 10, is copied to a pre-copy area 23 at a predetermined timing. That is, the original file 25 to be protected with respect to which a file descriptor acquisition request for update has been issued and with respect to which a request for file operation such as write into the data file has been issued using the file descriptor is copied to the pre-copy area 23. A pre-copy file 27, which is the original file 25 copied to the pre-copy area 23, is transferred to the work area 22 when the OS 50 is restarted. When the user accesses the same original file 25 as that prior to the restart, the operation device 10 changes the access destination from the original file 25 stored in the original storage area 21 to the pre-copy file 27 transferred to the work area 22. Specifically, the operation device 10 according to this embodiment detects that a file descriptor acquisition request for updating the original file 25 has been issued and acquires a file descriptor corresponding to the pre-copy file 27 of the original file 25, stored in the pre-copy area 23. The acquired file descriptor corresponding to the pre-copy file 27 is reported to the process of the use application, which is the request source. The operation device 10 then performs rewriting or the like of the copy file 26 in the work area 22 accessed using the acquired file descriptor in accordance with a user operation or the like.

Specifically, a request for operation of the data file to be protected, such as rewriting thereof, is issued by the process of the application, using the file descriptor corresponding to the data file stored in the work area 22. As a result, operation of the data file to be protected, such as rewriting thereof, can be avoided. During normal execution of an application, a file descriptor acquired to make the first access to a file may be reused to make the second and later accesses to the same file so that the need to issue a file descriptor acquisition request again is eliminated. This eliminates the need to perform the above-mentioned original file copy process or a file descriptor conversion process in order to make the second and later accesses to the same file. Also, after acquiring a file descriptor through the control according to this embodiment, each user application makes a request for access to a predetermined file not through the control according to this embodiment. This can eliminate the operation cost required by the control according to this embodiment.

The data file to be protected with respect to which a request for file operation such as rewrite has been issued by the process of the application is copied from the original storage area 21 to the pre-copy area 23 on the basis of history information indicating that the request has been issued. Specifically, the data file that is determined to be a file to be protected is replicated and then stored in a storage device as a data file different from the above-mentioned copy file 26, which is a work file. Thus, when the second and later accesses are made (particularly, after the OS 50 is restarted), the data file is transferred from the pre-copy area 23 to the work area 22. The speed of a data file transfer process is increased compared with that of a copy process. Accordingly, the time to be taken before the original file 25 is rewritten by the user at the time of operation with the pre-copy file 27 stored, for example, after the OS 50 is restarted can be reduced compared to that at the time of operation with the pre-copy file 27 not stored, for example, when the OS 50 is initially started.

While this embodiment has been described assuming that the information processing device 1 includes the operation device 10 and storage device 20 integrally, a configuration where these components are connected to each other via a network may be employed. For example, the storage device 20 may be a network attached storage (NAS). Alternatively, the storage device 20 may be a removal hard disk, universal serial bus (USB) memory, or the like. The information processing device 1 may be a computer such as a server.

Hereafter, the specific configuration and operation of the information processing device 1 for performing a file restoration process will be described in detail.

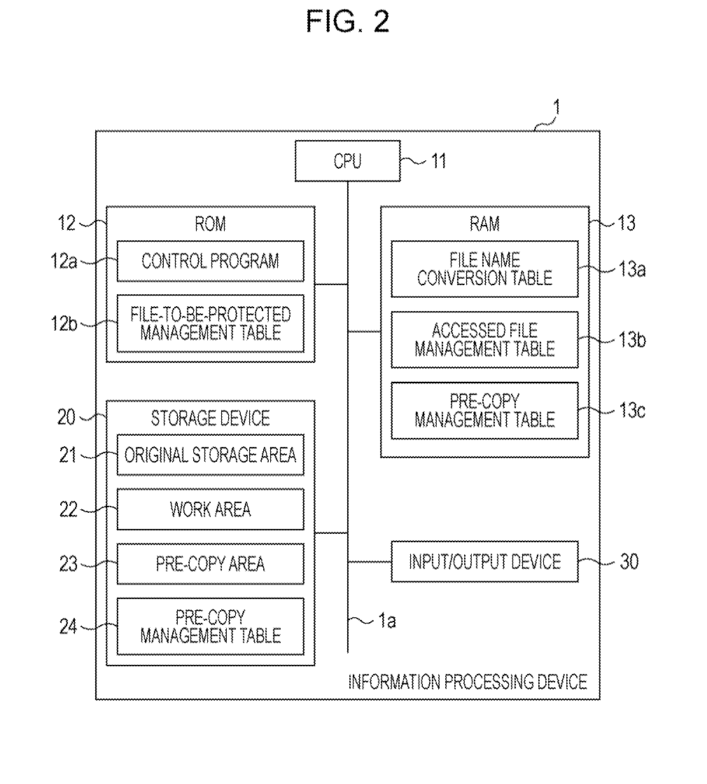

FIG. 2 is a schematic diagram illustrating an electric configuration of the information processing device 1 according to this embodiment. The information processing device 1 includes a central processing unit (CPU) 11, a read only memory (ROM) 12, and a random access memory (RAM) 13 constituting the above-mentioned operation device 10, and the hardware components of the above-mentioned storage device 20 and input/output device 30. These hardware components are connected to one another via a bus 1a.

The CPU 11 loads a control program previously stored in the ROM 12 into the RAM 13 as needed and executes it, as well as controls the operation of the above-mentioned hardware components. The ROM 12 previously stores various control programs 12a required to cause the information processing device 1 to operate as the information processing device disclosed in this application, a file-to-be-protected table 12b, and the like. The file-to-be-protected table 12b is a table for managing original files 25 to be protected (restored). The original files 25 designated as files to be protected in the file-to-be-protected table 12b are copied from the original storage area 21 to the work area 22, as described above. The file-to-be-protected table 12b may be created when installing a program for a file restoration process or may be created by the administrator. The file-to-be-protected table 12b may be rewritable. The control programs 12a, file-to-be-protected table 12b, and the like may be stored in the storage device 20.

The RAM 13 is, for example, a static RAM (SRAM), dynamic RAM (DRAM), flash memory, or the like. The RAM 13 temporarily stores various kinds of data generated when the CPU 11 executes the control program. The RAM 13 stores, for example, a file name conversion table 13a, an accessed file management table 13b, a pre-copy management table 13c, and the like.

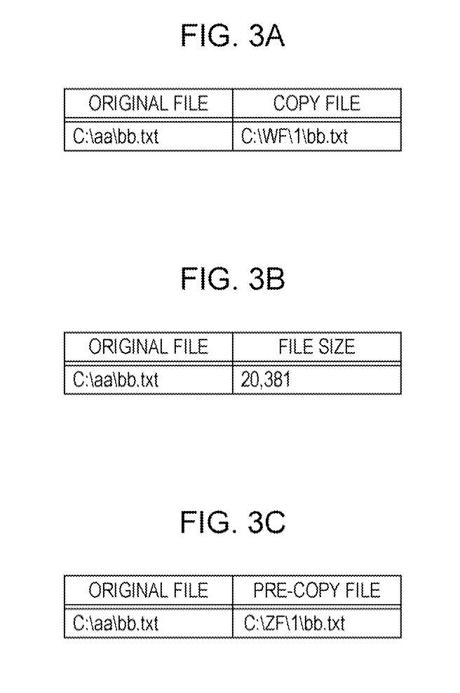

FIGS. 3A to 3C are diagrams schematically illustrating tables used when a file restoration process is performed. FIG. 3A illustrates the file name conversion table 13a, FIG. 3B illustrates the accessed file management table 13b, and FIG. 3C illustrates the pre-copy management table 13c.

The file name conversion table 13a illustrated in FIG. 3A is a table for associating an original file 25 stored in the original storage area 21 with a copy file 26 stored in the work area 22. For example, FIG. 3A indicates that “bb.txt”, which is an original file 25 stored at “C:\aa” of the original storage area 21, has been copied to “C:\WF\1” of the work area 22. The file name conversion table 13a is created when the original file 25 is copied to the work area 22.

The accessed file management table 13b illustrated in FIG. 3B is a table for managing an original file 25 accessed within a particular period. In other words, an original file 25 stored in the accessed file management table 13b is an original file 25 copied to the work area 22. The accessed file management table 13b is storing the size (e.g., in units of bytes) of the original file 25 accessed.

The pre-copy management table 13c illustrated in FIG. 3C is a table for associating an original file 25 stored in the original storage area 21 with its pre-copy file 27 stored in the pre-copy area 23. For example, FIG. 3C indicates that “bb.txt”, which is an original file 25 stored at “C:\aa” of the original storage area 21, has been copied to “C:\ZF\1” of the pre-copy area 23.

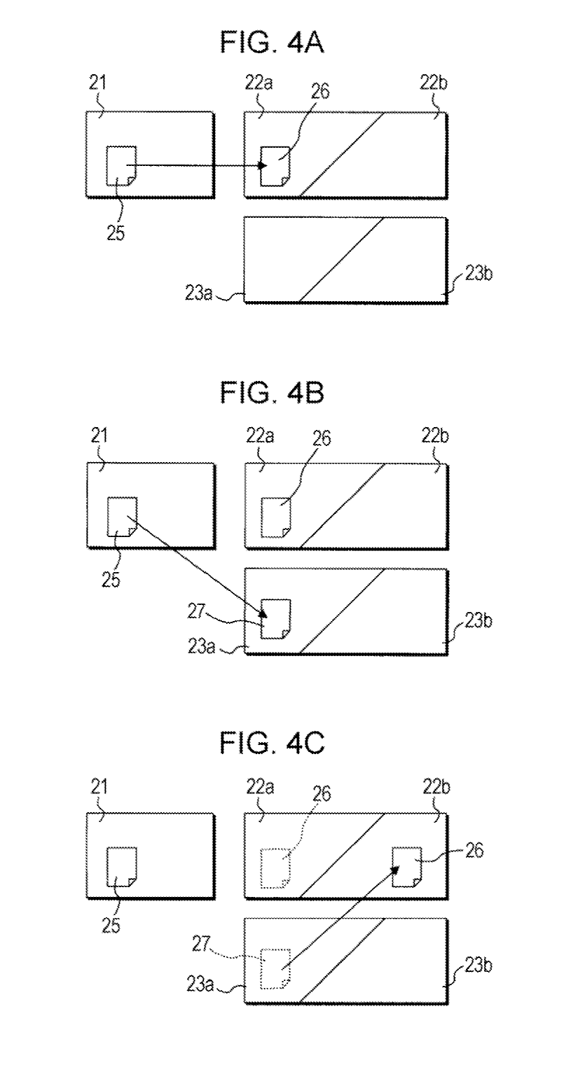

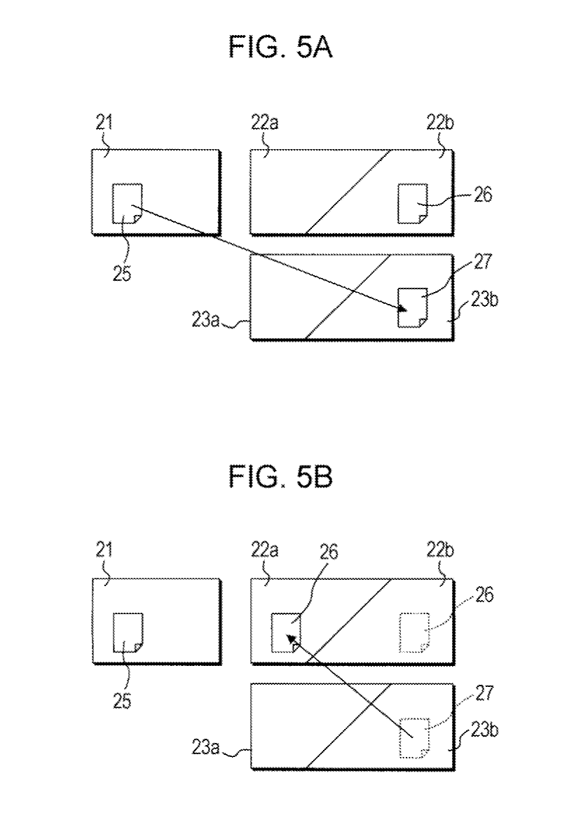

The storage device 20 includes the above-mentioned original storage area 21, work area 22, and pre-copy area 23. The work area 22 and pre-copy area 23 are each divided into two areas. Hereafter, the areas of the storage device 20 will be described in detail. FIGS. 4A to 4C and FIGS. 5A and 5B are schematic diagrams illustrating the original storage area 21, work area 22, and pre-copy area 23. The explanation will be made assuming that nothing is stored in the work area 22 nor pre-copy area 23 at first.

When it is detected that a file descriptor acquisition request has been issued to update an original file 25 stored in the original storage area 21, it is determined on the basis of the file-to-be-protected table 12b whether the original file 25 accessed is designated as a file to be protected. If the original file 25 is designated as a file to be protected, the original file 25 is copied to a first area 22a of the work area 22 (hereafter referred to as the first work area) (see FIG. 4A). At that time, a file name conversion table 13a is created so that the original file 25 and its copy file 26 are associated with each other. The file descriptor corresponding to the original file 25, specified by the acquisition request issued by the process of the application, is changed to a file descriptor corresponding to the copy file 26. The file descriptor corresponding to the copy file 26 is reported to the process that has issued the acquisition request.

Moreover, an accessed file management table 13b is created and stored in the RAM 13. If the file name conversion table 13a is referred to before performing the above-mentioned copy process and if it is determined that the file name of the original file 25 with respect to which a file descriptor acquisition request has been detected is already registered in the file name conversion table 13a, the copy process may be omitted. Specifically, if the original file 25 specified by the acquisition request is already registered in the file name conversion table 13a, a file descriptor corresponding to the copy file 26 registered in the file name conversion table 13a in a manner associated with the original file 25 is reported to the process that has issued the acquisition request.

Thus, the process that has issued the request for acquisition of the file descriptor corresponding to the original file 25 acquires the file descriptor corresponding to the copy file 26 that has been generated in the work area 22 on the basis of the contents of the original file 25. Subsequently, the process makes, to the OS 50, a request for performance of an operation, such as rewrite, on the copy file 26 using the file descriptor acquired. Upon receipt of the file operation performance request, the OS 50 refers to management information identified by the file descriptor, specified by the request, to identify the site at which data forming the file is stored. The OS 50 then reports an access instruction specifying the data storage site to the storage device 20. These processes are performed by the OS 50 in a traditional manner and will not be described in detail.

In this way, write into the original file 25, deletion thereof, or the like can be avoided. Also, the control program according to this embodiment does not need to detect any file operation performance request that the process issues using a file descriptor. That is, the control program according to this embodiment may detect only a file descriptor acquisition request issued by the process. Also, since the control program according to this embodiment detects only a file descriptor acquisition request for update and does not need to detect any file descriptor acquisition request for reference, the operation cost required for detection can be further reduced.

Subsequently, at a particular timing, the original file 25 with respect to which a file descriptor acquisition request for file update has been issued is copied to a first area (hereafter referred to as the first pre-copy area) 23a of the pre-copy area 23 on the basis of the accessed file management table 13b (see FIG. 4B). At that time, a pre-copy management table 24 is created and stored in the storage device 20. The pre-copy management table 24 is similar to the pre-copy management table 13c described with reference to FIG. 3C. In the following description, a process of copying an original file 25 to the pre-copy area 23 will be referred to as pre-copy. The processes in FIGS. 4A and 4B are repeated as long as the OS 50 operates.

When the information processing device 1 is started with the pre-copy file 27 stored, for example, when the OS 50 is restarted, the pre-copy management table 24 stored in the storage device 20 is loaded into the RAM 13. As in FIG. 4A, when a file descriptor acquisition request for updating an original file 25 stored in the original storage area 21 is detected, it is determined on the basis of the pre-copy management table 13c whether the original file 25 accessed has been pre-copied. If the original file 25 accessed has been pre-copied, the corresponding pre-copy file 27 stored in the first pre-copy area 23a is transferred to a second area (hereafter referred to as the second work area) 22b of the work area 22 (see FIG. 4C). At that time, the copy file 26 stored in the first area 22a is deleted. Copying the pre-copy file 27 stored to the second work area 22b allows deletion in the first work process 22a and transfer to the second work area 22b to be performed simultaneously, which can reduce the time.

Also, as in FIG. 4B, the original file 25 accessed is copied to a second area (hereafter referred to as the second pre-copy area) 23b of the pre-copy area 23 on the basis of the accessed file management table 13b at a particular timing (see FIG. 5A). Copying the original file 25 to the second pre-copy area 23b prevents overlap with transfer from the first pre-copy area 23a to the second work area 22b, which can reduce the time.

Also, as in FIG. 4C, when the OS 50 is restarted, the pre-copy file 27 in the second pre-copy area 23b is transferred to the first work area 22a on the basis of the pre-copy management table 13c (see FIG. 5B). At that time, the copy file 26 stored in the second work area 22b is deleted. As described with reference to FIG. 4C, copying the pre-copy file 27 to the first work area 22 allows deletion and transfer to be performed simultaneously, which can reduce the time.

Next, the process performed by the above-mentioned information processing device 1 will be described.

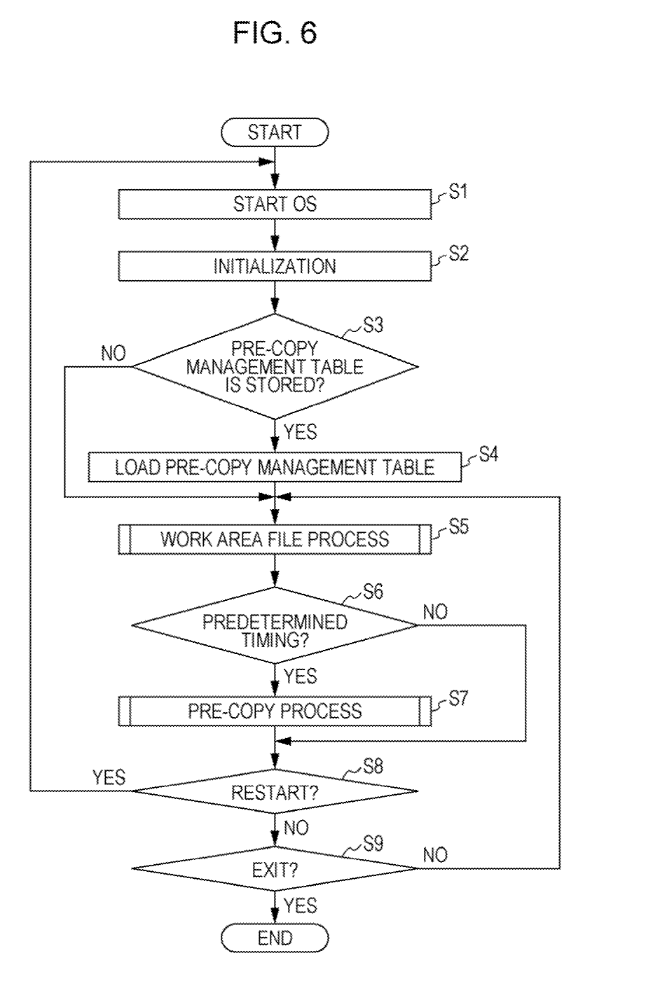

FIG. 6 is a flowchart illustrating the process performed by the information processing device 1.

The CPU 11 starts the OS 50 when the information processing device 1 is powered on (S1). The start of the OS 50 causes loading of a driver for performing file restoration so that a file restoration process is started.

Subsequently, the CPU 11 performs initialization (S2). Initialization is a process of performing initialization of the contents stored in the RAM 13, loading of the file-to-be-protected table 12b from the ROM 12 into the RAM 13, and the like. If a copy file 26 is stored in the work area 22, the CPU 11 deletes the copy file 26.

The CPU 11 determines whether a pre-copy management table 24 is already stored in the storage device 20 (S3). If a pre-copy management table 24 is already stored (S3: YES), the CPU 11 loads the pre-copy management table 24 into the RAM 13 (S4). If no pre-copy management table 24 is stored (S3: NO) or after the CPU 11 loads the pre-copy management table 24 into the RAM 13, the CPU 11 performs a work area file process (S5).

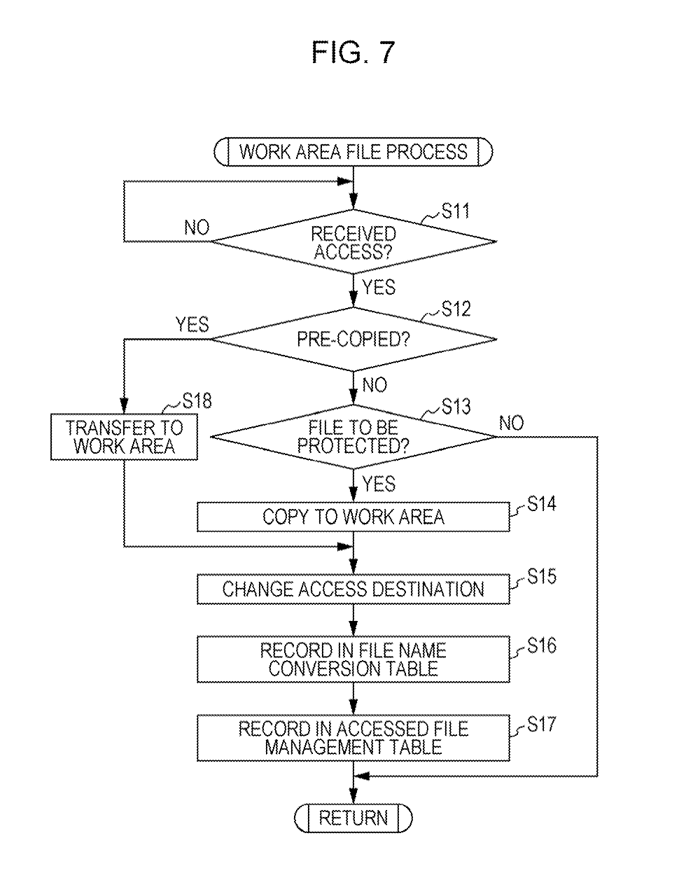

FIG. 7 is a flowchart illustrating a work area file process.

In the work area file process, the CPU 11 determines whether it has received an access to an original file 25 stored in the original storage area 21 (S11). “Receive an access” refers to, for example, receiving specification of the name of an original file 25 by the application 51 and receiving a request for update of the original file 25 made by the application 51. “Receive an access” may be done, for example, by inputting a command or selecting the icon of a data file. If the CPU 11 has received no access (S11: NO), the CPU 11 will wait until it receives. At that time, the CPU 11 may perform other processes in the information processing device 1 or may proceed to another process after a predetermined time elapses.

If the CPU 11 receives an access, that is, receives a file descriptor acquisition request for file update (S11: YES), it determines whether the access destination original file 25 has been pre-copied (S12). Specifically, the CPU 11 refers to the pre-copy management table 13c stored in the RAM 13 to determine whether the target original file 25 is stored in the pre-copy management table 13c. If the access destination original file 25 has not been pre-copied (S12: NO), the CPU 11 refers to the file-to-be-protected table 12b to determine whether the access destination original file 25 is a file to be protected (S13).

If the access destination original file 25 is a file to be protected (S13: YES), the CPU 11 copies the access destination original file 25 to the work area 22 (S14). In S14, if the corresponding copy file 26 is not stored in the first work area 22a, the CPU 11 copies the original file 25 to the first work area 22a. If the corresponding copy file 26 is stored in the first work area 22a, the CPU 11 copies the original file 2 to the second work area 22b. Alternatively, the CPU 11 may determine whether the access destination original file 25 received in S11 is stored in the original storage area 21 and, if stored, may copy that original file. This avoids the contents of an original file 25 deleted from the original storage area 21 from being unintentionally continuously used through its copy file 26 stored in the work area 22.

Next, the CPU 11 changes the access destination received in S11 to the copy file 26 stored in the first work area 22a (S15). In later processes, the CPU 11 will access the copy file 26 stored in the first work area 22a. That is, when a user attempts to rewrite the target original file 25, the CPU 11 rewrites its copy file 26 stored in the first work area 22a.

Next, the CPU 11 records the copy result in the file name conversion table 13a (S16). If no file name conversion table 13a is present in the RAM 13, the CPU 11 creates a file name conversion table 13a and stores it in the RAM 13. The CPU 11 then records information on the accessed original file 25 (e.g., file name and file size) in the accessed file management table 13b (S17). The CPU 11 then completes the work area file process and proceeds to S6 of FIG. 6.

If the access destination is not a file to be protected in S13 (S13: NO), the CPU 11 completes the work area file process without changing the access destination and proceeds to S6 of FIG. 6. In this case, when the user attempts to rewrite the target original file 25, the CPU 11 accesses the target original file 25 stored in the original storage area 21 and rewrites it.

If the original file 25 has been pre-copied in S12 (S12: YES), the CPU 11 transfers its pre-copy file 27 stored in the pre-copy area 23 to the work area 22 (S18). At that time, if no copy file 26 is stored in the first work area 22a, the CPU 11 transfers the pre-copy file 27 to the first work area 22a. If any copy file 26 is stored in the first work area 22a, the CPU 11 transfers the pre-copy file 27 to the second work area 22b. The CPU 11 then proceeds to S15 and changes the access destination received in S11 to the copy file 26 stored in the work area 22 (S15). Specifically, in S15, the CPU 11 acquires a file descriptor corresponding to the copy file 26 stored in the work area 22 and reports the acquired file descriptor to the process that has issued the acquisition request.

Specifically, the CPU 11 acquires a file descriptor in S15 as follows. When the CPU 11 detects a file descriptor acquisition request, it acquires information on the process that has issued the acquisition request. The information acquired contains a process ID for identifying the process that has issued the acquisition request. The CPU 11 acquires a process control block (also called a task control block) managed by the OS 50 from the process ID. The CPU 11 then determines whether, as an entry managed in the data structure of the process control block (also called a file access management book), a file control block of the copy file 26 corresponding to the file with respect to which an acquisition request has been issued is registered. If a corresponding file control block is already registered as such an entry, the CPU 11 returns the number of the entry to the process, which is the acquisition request source, as a file descriptor.

Conversely, if not registered, the CPU 11 acquires, from the OS 50, the file control block of the copy file 26 corresponding to the file with respect to which an acquisition request has been issued and registers the file control block in one of the entries managed by the data structure of the process control block. The CPU 11 then sets open mode specified by the acquisition request in that entry. For example, open mode indicating update such as write or additional write is set by a file descriptor acquisition request for update. Open mode indicating reference such as read only is set by a file descriptor acquisition request for reference. The CPU 11 then returns the number of the entry, in which the file control block is registered, to the process, which is the acquisition request source, as a file descriptor. If the process, which has received the report in S15, makes a file operation performance request to the OS using the acquired file descriptor, the process will access the copy file 26 stored in the first work area 22a.

The CPU 11 determines whether a predetermined timing has come (S6). “A predetermined timing” refers to, for example, the timing at which the frequency with which a request for access to the storage device 20 is received (the frequency with which an access request is received in a predetermined time unit) falls below a predetermined value or the timing at which a predetermined time has elapsed since the time of start of the OS 50 or the like. A predetermined timing may be the timing at which a request for load of a predetermined program (e.g., a login screen display program or a program that is automatically started after login) is received by the CPU 11 or the timing at which a predetermined time has elapsed since reception of a load request. When the predetermined timing has come (S6: YES), the CPU 11 performs a pre-copy process (S7). When a predetermined timing has not come (S6: NO), the CPU 11 proceeds to S8.

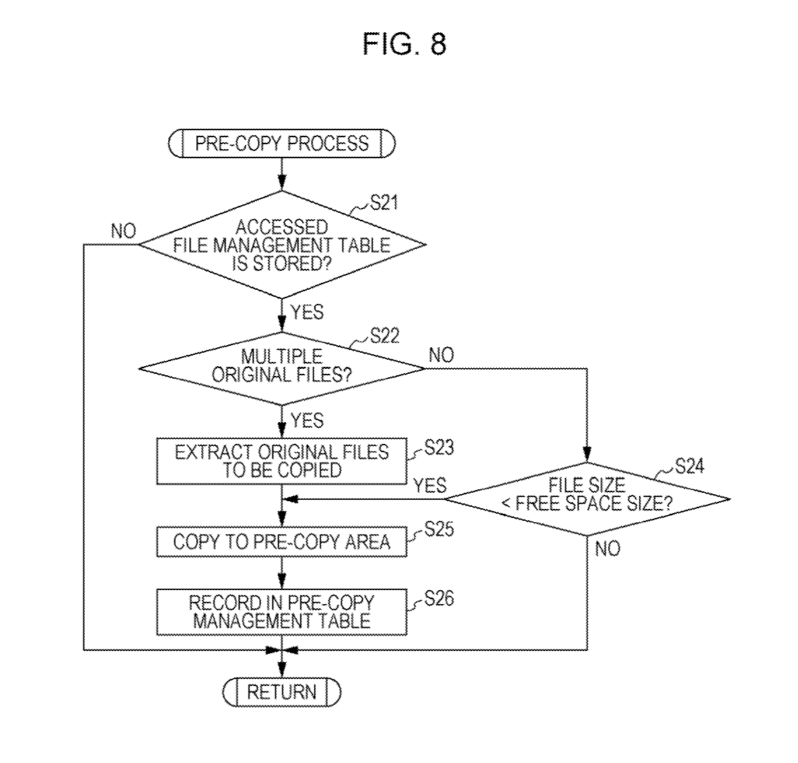

FIG. 8 is a flowchart illustrating a pre-copy process.

In the pre-copy process, the CPU 11 determines whether an accessed file management table 13b is stored in the RAM 13 (S21). In other words, the CPU 11 determines whether the original file 25 to be protected has been copied to the work area 22 in the work area file process. If no accessed file management table 13b is stored in the RAM 13 (S21: NO), the CPU 11 completes the pre-copy process and proceeds to S8 of FIG. 6.

If an accessed file management table 13b is stored in the RAM 13 (S21: YES), the CPU 11 determines whether multiple original files 25 are stored in the accessed file management table 13b (S22). If multiple original files 25 are not stored (S22: NO), the CPU 11 determines whether the size of an original file 25 stored in the accessed file management table 13b falls below the free space size of the work area 22 (S24). If the file size falls below the free space size (S24: YES), the CPU 11 copies the original file 25 to the pre-copy area 23 (S25). If the file size does not fall below the free space size (S24: NO), the CPU 11 completes the pre-copy process without copying the original file 25 to the pre-copy area 23 and proceeds to S8 of FIG. 6.

If multiple original files 25 are stored (S22: YES), the CPU 11 extracts original files 25 to be copied to the pre-copy area 23 (S23). For example, an original file 25 whose size exceeds a predetermined value (a first threshold) may be excluded from files to be copied. This prevents a file of significantly large size from occupying the pre-copy area 23. An original file 25 whose size falls below a predetermined value (a second threshold) may be excluded from files to be copied. If an original file 25 is small in size, the time required to copy the original file 25 to the work area 22 is negligible. Accordingly, if all the original files 25 stored in the accessed file management table 13b cannot be copied to the pre-copy area 23, original files 25 that are large in size and require a nonnegligible time to be copied may be copied to the pre-copy area 23 preferentially. Either of different values and the same value may be set for the above-mentioned first and second thresholds. As for the control using the above-mentioned first threshold and the control using the second threshold, one or both of these types of control may be implemented. If both types of control are implemented, it is preferable to set, for the first threshold, a larger value than the second threshold. In this case, a file having a size not more than the first threshold and not less than the second threshold can be a file to be pre-copied.

Alternatively, all the original files 25 stored in the accessed file management table 13b may be copied to the pre-copy area 23. Alternatively, original files 25 of smaller sizes may be copied to the pre-copy area 23 preferentially. Thus, in a case where the time that can be ensured to perform a pre-copy process is not determined, the number of files to be stored in the pre-copy area 23 can be increased. The CPU 11 may copy files in the descending order of file size. Thus, in a situation where the time that can be ensured to perform a pre-copy process is not determined, original files 25 requiring longer times to be copied can be stored in the pre-copy area 23 preferentially.

Next, the CPU 11 copies the extracted original files 25 to the pre-copy area 23 (S25). If no pre-copy file 27 is stored in the first pre-copy area 23a nor the second pre-copy area 23b, the CPU 11 copies the extracted original files 25 to the first pre-copy area 23a. If a pre-copy file 27 is stored in any one of the first pre-copy area 23a and second pre-copy area 23b, the CPU 11 copies the extracted original files 25 to the other pre-copy area. The CPU 11 then records the copy results to the pre-copy area 23 in the pre-copy management table 24 stored in the storage device 20 (S26). At that time, if no pre-copy management table 24 is stored in the storage device 20, the CPU 11 creates a pre-copy management table 24 and stores it in the storage device 20. The CPU 11 then completes the pre-copy process and proceeds to S8 of FIG. 6.

If the predetermined timing has not come in S6 (S6: NO) or after the pre-copy process in S7 is completed, the CPU 11 determines whether the OS 50 should be restarted (S8). If the OS 50 should be restarted (S8: YES), the CPU 11 restarts the OS 50 and returns to S1. If the OS 50 should not be restarted (S8: NO), the CPU 11 determines whether this process should be completed, that is, whether the OS 50 should be exited (S9). If the process should not be completed (S9: NO), the CPU 11 returns to S5. During repeated performance of the work area file process after returning to S5, the CPU 11 omits S18 if the pre-copy file 27 has been transferred from the pre-copy area 23 to the work area 22 in S18 of FIG. 7. If the CPU 11 determines that this process should be completed (S9: YES), it exits the OS 50 to complete this process.

As described above, in this embodiment, when the CPU 11 detects that a file descriptor acquisition request to update an original file 25 to be protected has been issued, it generates a copy file 26 of the original file 25 in the work area 22 on the basis of the contents of the original file 25. When an access for reference to an original file 25 is made, the CPU 11 returns a file descriptor for directly referring to the original file 25 to the application. This allows the application to directly refer to the original file 25. When an access for generation of a new file is made, the CPU 11 generates a data file for the new file in the work area 22 and returns the file descriptor of the data file. This can prevent traces of file generation from being left in the original storage area 21. When there is made an access for a reference to a file that has been already updated and whose copy file 26 has been generated in the work area 22, returning the file descriptor of the generated copy file 26 allows continuous reference to the updated file. In this case, in a process by the control program according to this embodiment, it is preferable to detect a file descriptor acquisition request for referring to a file as well and identify a backup file associated with the file specified by the detected acquisition request in the file name conversion table 13a.

The information processing device according to this embodiment causes the process that has issued a file descriptor acquisition request to acquire a file descriptor corresponding to the copy file 26 and to make a file operation request using the acquired file descriptor. This prevents the target original file 25 from being changed as well as being accessed by a user, which can reduce the possibility of the original file's corruption or the like. Deletion of the corresponding copy file 26 stored in the work area 22 can instantly put the target original file 25 in a restored state.

Moreover, the target original file 25 is pre-copied, and its pre-copy file 27 is transferred to the work area 22 after restart of the OS 50. Thus, the processing time can be reduced compared with a case where the original file 25 is copied from the original storage area 21 to the work area 22.

While the embodiment has been described specifically, the invention is not limited thereto. Changes can be made to the configuration, operation, and the like of the embodiment as appropriate.

For example, the above-mentioned embodiment employs a configuration where the pre-copy file 27 generated by pre-copying the original file 25 to the pre-copy area 23 is transferred to the work area 22; however, a configuration where the pre-copy area 23 and the work area 22 exchange their roles may be employed. For example, by handling the pre-copy area 23 as the work area 22, the pre-copy file 27 stored in the pre-copy area 23 may be accessed when the OS 50 is restarted, and the original file 25 may be pre-copied to the work area 22.

The areas 21, 22, and 23 may be implemented using physical sections (e.g., partitions, drives, etc.) set on a medium or logical sections (e.g., files) hierarchically set on a system file. The name of a data file may vary among the areas 21, 22, and 23 storing the data file. For example, the copy file 26 and pre-copy file 27 may be identified by adding an identifier to the end of the name of the original file 25 or replacing an extension at the end of the name of the original file 25 with another. The extension may vary among the files. For example, the copy file 26 stored in the work area 22 may have the extension “Amp” and the pre-copy file 27 stored in the pre-copy area 23 may have the extension “.pre”. In this case, the files can be stored in the same area.

While the embodiment has been described assuming that the CPU 11 performs the control program 12a stored in the ROM 12, the CPU 11 may read the control program from a storage medium, such as a compact disk-ROM (CD-ROM), to perform the above-mentioned process.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing device comprising:
a storage to store a plurality of original files; and
a processor to execute a first process including:
obtaining an acquisition request to request an acquisition of a first file descriptor assigned to a first file specified among the original files, the acquisition request being generated in a second process executed by the processor,
determining whether or not the first file is designated as a file to be protected,
generating a second file on a basis of the first file when the first file is determined to be designated as the file to be protected, and
acquiring a second file descriptor assigned to the second file in reply to the acquisition request.

2. The information processing device according to claim 1, wherein the first file descriptor is used for identifying the first file, and the second file descriptor is used for identifying the second file.

3. The information processing device according to claim 1, wherein each of the original files is a control file for controlling an environment in which the second process is executed.

4. The information processing device according to claim 1, wherein the processor executes generating a rewriting request to rewrite the second file to which the second file descriptor is assigned in the second process.

5. The information processing device according to claim 1, the first process further including:
storing associating information associating the second file with the first file,
wherein the processor executes the acquiring the second file descriptor assigned to the second file associated with the first file in the associating information when the associating information is remains stored.

6. The information processing device according to claim 1, wherein the processor executes the generating the second file by replicating the first file.

7. The information processing device according to claim 1, the first process further including:
deleting the second file when the information processing device is finished or started.

8. The information processing device according to claim 7, the first process further including:
generating a third file different from the second file on a basis of the first file, when the first file is determined to be designated as the file to be protected,
storing associating information associating the third file with the first file,
obtaining another acquisition request to request another acquisition of the first file descriptor after the information processing device is restarted, and
acquiring a third file descriptor assigned to the third file associated with the first file in the associating information in reply to the another acquisition request, when the associating information is remains stored upon obtaining the another acquisition request for the first time after the information processing device is restarted.

9. The information processing device according to claim 8, wherein the processor executes the generating the third file by replicating the first file.

10. The information processing device according to claim 8, wherein the processor executes the generating the third file when a frequency with which the acquisition request is received falls below a given value.

11. The information processing device according to claim 8, wherein the processor executes the generating the third file when a given time elapses since the information processing device is started.

12. The information processing device according to claim 8, wherein the processor executes the generating the third file when the first file is determined to be a given file.

13. The information processing device according to claim 8, wherein the processor executes the generating the third file when a given time elapses since the first file is determined to be a given file.

14. The information processing device according to claim 8, the first process further including:
storing accessed file information associating the first file determined to be designated as the file to be protected with a file size of the first file,
wherein the generating the third file includes:
comparing the file size of the first file with a given value, and
generating the third file when the file size of the first file exceeds the given value.

15. The information processing device according to claim 8, the first process further including:
storing accessed file information associating the first file determined to be designated as the file to be protected with a file size of the first file,
wherein the generating the third file includes:
comparing the file size of the first file with a given value, and
generating the third file when the file size of the first file falls below the given value.

16. The information processing device according to claim 8, the first process further including:
storing accessed file information associating the first file determined to be designated as the file to be protected with a file size of the first file,
wherein the third file is generated on a basis of a first file which has a file size smaller than a file size of another first file among the first files, each of the first files being associated with the file size in the accessed file information preferentially in the generating the third file.

17. The information processing device according to claim 8, the first process further including:
storing accessed file information associating the first file determined to be designated as the file to be protected with a file size of the first file,
wherein the third file is generated on a basis of a first file which has a file size larger than a file size of another first file among the first files, each of the first files being associated with the file size in the accessed file information preferentially in the generating the third file.

18. A non-transitory computer readable storage medium storing a program causing a computer to execute a first process, the first process comprising:
obtaining an acquisition request to request an acquisition of a first file descriptor assigned to a first file specified among a plurality of original files, the acquisition request being generated in a second process executed by the computer;
determining whether or not the first file is designated as a file to be protected;
generating a second file on a basis of the first file when the first file is determined to be designated as the file to be protected; and
acquiring a second file descriptor assigned to the second file in reply to the acquisition request.

19. An information processing device comprising:
an acquisition request reception unit for receiving an acquisition request to request an acquisition of a first file descriptor assigned to a first file specified among a plurality of original files from a process executed by a processor;
a determining unit for determining whether or not the first file is designated as a file to be protected;
a file generation unit for generating a second file on a basis of the first file when the first file is determined to be designated as the file to be protected; and
an acquisition request report unit for reporting a second file descriptor assigned to the second file to the process.
